(19) United States
(12) Patent Application Publication
(10) Pub. No.: US 2026/0326335 A1
(43) Pub. Date: Oct. 22, 2026

(54) FOLDABLE LITHIUM ELECTRIC SAW

(71) Applicant: Yongkang Qingwei Industry and Trade Co., Ltd., Jinhua (CN)

(72) Inventor: YIMIN LV, Jinhua (CN)

(21) Appl. No.: 19/451,012

(22) Filed: Jan. 16, 2026

(30) Foreign Application Priority Data
Apr. 21, 2025 (CN) 202510499871.0

(51) Int. Cl. B27B 17/08; B27B 17/02; B27B 17/14

(52) U.S. Cl. CPC B27B 17/08; B27B 17/02; B27B 17/14

(57) ABSTRACT

Provided is a foldable lithium electric saw, which includes a drive device, a tool assembly, a first support device, a second support device, and an adjusting mechanism. The drive device provides power to the tool assembly through the drive shaft. The tool assembly includes a chain, a sprocket, and a chain guide plate, with the sprocket and chain guide plate cooperating to support the chain. The drive device is provided on the first installation part, and the drive shaft is arranged perpendicular to an extension direction of the first support device. The second support device is configured to slidably support the chain guide plate, and the second support device is configured to rotate around the drive shaft relative to the first installation part. The chain guide plate and chain rotate synchronously with the second support device to switch the tool assembly between an initial state and a folded state.

### CROSS-REFERENCE TO RELATED APPLICATIONS

This application claims priority to Chinese Patent Application No. 202510499871.0, filed on Apr. 21, 2025, which is hereby incorporated by reference in its entirety.

### TECHNICAL FIELD

The present disclosure relates to the field of chainsaw technologies, and in particular, to a foldable lithium electric saw.

### BACKGROUND

In modern forestry, garden maintenance, and outdoor operations, electric saws are an efficient cutting tool with extremely high frequency of use. Lithium electric saws are gradually emerging due to their advantages such as no power cord constraints and flexible operation. However, there is still room for improvement in the portability and tool angle adjustment of existing lithium electric saws, especially for personnel who need to work in the field for long periods of time or frequently switch between different sites. How to further improve the portability and flexibility of the electric saw and ensure its performance has become an urgent problem to be solved in the industry. Although existing foldable chainsaws can achieve partial folding, they often have problems such as poor structural stability and easy loosening of rotating joints. Meanwhile, the chain tension adjustment of existing lithium electric saws usually adopts a bolt push structure, which is cumbersome to operate and prone to rollback. Besides that, the lubrication system of tool components often relies on manual oiling, making maintenance inconvenient.

### SUMMARY

The purpose of the present disclosure is to provide a foldable lithium electric saw to meet needs of a user, in response to the shortcomings of the existing technology mentioned above.

To achieve the above objectives, the present disclosure provides a foldable lithium electric saw, including:
a drive device, which includes a drive shaft;
a tool assembly, which includes a chain, a sprocket, and a chain guide plate, where the sprocket is connected to the drive shaft for transmission, the sprocket is configured to be fixed to the drive shaft, the sprocket and the chain guide plate are configured to cooperate to support the chain, and the sprocket meshes with the chain;
a first support device, which includes a grip part and a first installation part provided at one end of the grip part, the drive device is provided on the first installation part, and the drive shaft is arranged perpendicular to an extension direction of the first support device;
a second support device, configured to slidably support the chain guide plate, where the second support device is configured to rotate around the drive shaft relative to the first installation part, and the chain guide plate and the chain rotate synchronously with the second support device to switch the tool assembly between an initial state and a folded state;
an adjusting mechanism, configured to adjust a tension of the chain by driving the chain guide plate to approach/move away from the sprocket along its length direction;
a lithium battery, which can supply energy to the drive device, the lithium battery is provided at the other end of the grip part;
where, in the initial state, an extension direction of the chain guide plate is parallel to the extension direction of the first support device and extends outward away from the grip part; in the folded state, the extension direction of the chain guide plate is parallel to the extension direction of the first support device, and the chain guide plate extends toward the grip part; the tool assembly is configured to switch from the initial state by rotating 180° to the folded state.

In some embodiments of the present disclosure: in the folded state, an overall size of the chainsaw is significantly reduced, and an overall length h2 after folding is shortened to 50%-60% of an initial overall length h1.

In some embodiments of the present disclosure, the second support device includes a rotation guide plate and a cover plate, where the rotation guide plate and the cover plate are configured to be assembled along a direction of the drive shaft and define a cavity, the cavity includes an outlet, the sprocket is provided in the cavity, the drive shaft is configured to extend into the cavity and connect the sprocket, and the chain guide plate extends out of the cavity through the outlet.

In some embodiments of the present disclosure, the first installation part defines a first cavity, and at least a part of the drive device is provided in the first cavity.

In some embodiments of the present disclosure, the outlet is provided with comb teeth that can automatically clean wood chips and branches wrapped around the chain.

In some embodiments of the present disclosure, the first installation part includes a first rotation surface, and the rotation guide plate includes a second rotation surface and a third rotation surface that are arranged opposite to each other; the second rotation surface is arranged opposite to the first rotation surface, and the third rotation surface is provided with a guide rail; the chain guide plate includes a guide sliding groove arranged along its length direction, and the guide rail is in a reciprocating sliding cooperation with the guide sliding groove to eliminate deflection errors during adjustment.

In some embodiments of the present disclosure, the adjusting mechanism includes an adjustment knob and a cam assembly, where the cam assembly includes a disk-shaped cam and a follower connected by a transmission, the follower is connected to the chain guide plate, the disk-shaped cam is connected to the adjustment knob, and the adjustment knob drives the disk-shaped cam to rotate, thereby driving the chain guide plate to approach/move away from the sprocket through the follower.

In some embodiments of the present disclosure, the follower includes a driven flat plate and a driven convex block that are integrated, the disk-shaped cam, the driven flat plate, and the chain guide plate are parallel to each other; the driven flat plate is connected to the chain guide plate, the driven convex block includes a driven plane, the driven plane is arranged perpendicular to a length direction of the chain guide plate, an outer contour of the disk-shaped cam is in contact with the driven plane, and when the disk-shaped cam rotates, a force between the disk-shaped cam and the follower is arranged along the length direction of the chain guide plate.

In some embodiments of the present disclosure, the rotation guide plate is detachably connected to the cover plate through a bolt structure, making it easy to disassemble and maintain. The bolt structure includes a T-shaped screw, a nut, and a tightening knob. The T-shaped screw is installed on the rotation guide plate, and the tightening knob is fixedly connected to the nut. The tightening knob is provided on an outside of the cover plate, and the nut extends into the second cavity and is connected to threads by threaded connection. The T-shaped screw is arranged along the direction of the drive shaft.

In some embodiments of the present disclosure, the adjustment knob is arranged on an outer side of the cover plate, and is coaxially arranged with the tightening knob. The tightening knob cooperates with the cover plate to form an axial limit on the adjustment knob, and the nut is configured to pass through the adjustment knob and forms a radial limit on it.

In some embodiments of the present disclosure, the foldable lithium electric saw includes a locking mechanism configured to limit a rotation of the second support device relative to a first support device,
where the locking mechanism includes:
at least one locking groove extending inward perpendicular to the first rotation surface;
a locking pin, which is extendable and provided on the second support device and is arranged parallel to the direction of the drive shaft,
a locking knob, configured to drive the locking pin to rotate or separate from the locking groove to achieve locking/unlocking; when the locking pin is inserted into the at least one locking groove, the tool assembly is in the initial state;
a reset spring, configured to drive the locking pin to withdraw from the at least one locking groove to maintain an unlocked state.

In some embodiments of the present disclosure, the locking pin includes a first stop portion protruding radially along the locking pin, the second support device is provided with an unlocking groove, and a stop ring is provided inside the unlocking groove; the first stop portion is in contact with the stop ring to limit the locking pin from disengaging from the unlocking groove, and two ends of the reset spring are in contact with the stop ring and the locking knob; the reset spring drives the locking pin to remain completely accommodated in the unlocking groove.

In some embodiments of the present disclosure, the first rotation surface is provided with a rotating shaft part, the rotation guide plate is provided with a shaft sleeve portion, the shaft sleeve portion is sleeved on the rotating shaft part, a compression component is provided on the third rotation surface, the compression component is connected to the rotating shaft part and forms an axial limit on the rotation guide plate; where the compression component includes an annular compression plate, an inner ring portion of the compression plate is connected to the rotating shaft part through a plurality of screws, and an outer ring portion of the compression plate is in contact with the shaft sleeve portion.

In some embodiments of the present disclosure, the third rotation surface includes a sector limit portion arranged around the shaft sleeve portion, the sector limit portion includes a plurality of limit slots uniformly distributed in a circumferential direction, and the compression component includes limit claws extending outward from the compression plate; when the second support device rotates, the limit claws are configured to be engaged with the limit slots one by one.

In some embodiments of the present disclosure, the compression component further includes a positioning block, and the positioning block is surrounded by the compression plate to form a positioning groove. The rotation guide plate includes a convex platform provided on the third rotation surface, and a guide rail is provided on the convex platform. The convex platform includes a positioning protrusion, and when the positioning protrusion is inserted into the positioning groove, the tool assembly is in the initial state, and the second support device can only rotate in one direction.

In some embodiments of the present disclosure, the limit claws include a cantilever portion extending radially outward along one of the compression plate and a claw portion provided at a free end of the cantilever portion, the claw portion has a V-shaped structure.

In some embodiments of the present disclosure, the first rotation surface includes a plurality of indicator marks, and the cover plate includes an indicator arrow that is configured to be selectively aligned with one of the indicator marks to indicate a rotation angle; the at least one locking groove comprises locking grooves correspongding one-to-one with the indicator marks, and each of the locking grooves and its corresponding indicator mark are symmetrical about a center of the sprocket. A user can intuitively understand a folding angle and a state of the device, rendering an operation more intuitive and convenient.

In some embodiments of the present disclosure, an angle between two adjacent indicator marks is N times an angle between two adjacent limit slots, where N is a natural number not greater than 18.

In some embodiments of the present disclosure, the first rotation surface is provided with an oil injection hole, and the rotation guide plate includes an oil guide groove provided on the second rotation surface, an oil storage tank provided on the third rotation surface, and an oil guide hole commutating the oil guide groove and the oil storage tank; the oil guide groove is arranged towards the first rotation surface, and inner and outer sides of the oil guide groove in a radial direction are respectively provided with a first sealing ring and a second sealing ring; the oil storage tank is arranged towards the chain; the first installation part is provided with an oil pot storing lubricating oil and an oil pump; the oil pump is configured to pump the lubricating oil into the oil guide groove through the oil injection hole, and then the lubricating oil flows into the oil storage tank and lubricates the chain. Compared to the existing technology of placing the oil injection hole in the first installation part, this design can prevent the lubricating oil splashing and achieve higher overall cleanliness.

In some embodiments of the present disclosure, the first support device includes a left shell and a right shell, where the left shell and the right shell are configured to be assembled along the direction of the drive shaft and define the grip part and the first installation part. The detachable left and right shells facilitate the installation of drive device, the oil pump, the oil pot, etc.

In some embodiments of the present disclosure, the first rotation surface is further provided with a hollow area, through which the user can observe remaining oil in the oil pot, timely replenish lubricating oil, ensure that the chain is always in good lubrication condition, extend the service life of the chain and electric saw, and reduce maintenance costs. The oil pot is provided with an oil inlet nozzle, and the oil inlet nozzle protrudes from the first shell and is exposed to the outside.

In some embodiments of the present disclosure, an upper surface of the first installation part is rotatably provided with a protective board, and a left side of the first installation part is provided with an auxiliary handle.

The beneficial effects of the present disclosure are as follows.

1. Through the unique design of the second support device, the chain guide and the chain can rotate 180° around the drive shaft relative to the first installation part, thereby achieving a switch from the initial state to the folded state. In the folded state, the overall size of the chainsaw is significantly reduced, and the overall length is shortened to 50%-60% of the initial state after folding, rendering it convenient for the user to carry to various work sites.

2. The adjusting mechanism adopts a combination of adjustment knob and cam component. The user only needs to rotate the adjustment knob to drive the disk-shaped cam to rotate, and then precisely drive the chain guide plate along its length direction to approach or move away from the sprocket through the follower, thereby achieving fast and accurate adjustment of the chain tension.

3. The setting of the locking mechanism provides strong guarantee for the safe use of the electric saw. When the locking pin is inserted into the locking grooves, the tool assembly is fixed in its initial state and cannot rotate freely, thereby effectively avoiding accidents caused by tool rotation and injury due to misoperation. Besides that, by providing multiple locking pins, the tool assembly can be fixed at different angles to adapt to different work sites. Furthermore, the design of the reset spring enables the locking pins to automatically reset after the unlocking operation is completed, maintaining the unlocked state and facilitating the adjustment of the tool angle by rotating the second support mechanism.

4. The multi-angle locking mechanism of the sector limit portion and limit claws, combined with the locking mechanism, achieves dual locking to prevent the tool assembly from rotating in unexpected situations, avoiding operator injuries, and improving the safety of the electric saw during use. One single limit slot can achieve precise positioning with a minimum rotation angle of 10°. It is equipped with an indicator with an angle scale and an arrow mark for synchronous rotation. Combined with the tactile feedback of the limit claws, it achieves dual perception of folding angle.

5. The lubrication system composed of oil injection hole, oil guide groove, oil storage tank, and the oil guide hole allows the lubricating oil to be pumped from the oil pot through the oil injection hole into the oil guide groove, and then into the oil storage tank to lubricate the chain. The entire process is smooth and efficient. Furthermore, the oil guide groove is oriented towards the first rotation surface. When lubricating oil flows through the oil guide groove, it can also lubricate the first and second rotation surfaces, improving the smoothness of the rotation process.

### BRIEF DESCRIPTION OF DRAWINGS

FIG. 1 is a schematic diagram of an initial state of a foldable lithium electric saw provided by the present disclosure.

FIG. 2 is a front view of the initial state of the foldable lithium electric saw provided by the present disclosure.

FIG. 3 is a schematic diagram of a folded state of the foldable lithium electric saw provided by the present disclosure.

FIG. 4 is a front view of the foldable lithium electric saw provided by the present disclosure in the folded state.

FIG. 5 is a schematic structural diagram of a first support device and related components provided by the present disclosure.

FIG. 6 is a schematic structural diagram of a second support device and a tool assembly provided by the present disclosure.

FIG. 7 is a schematic diagram of a partial cross-sectional structure of the second support device and tool assembly provided by the present disclosure.

FIG. 8 is another schematic sectional structure diagram of the second support device and tool assembly provided by the present disclosure.

FIG. 9 is an assembly schematic diagram of a rotation guide plate and a compression component provided by the present disclosure.

FIG. 10 is a schematic diagram of an assembly of the rotation guide plate and the compression component provided by the present disclosure from another angle.

FIG. 11 is a schematic structural diagram of the rotation guide plate provided by the present disclosure.

FIG. 12 is a schematic structural diagram of a cam assembly provided by the present disclosure.

FIG. 13 is a schematic diagram of the foldable lithium electric saw provided by the present disclosure after rotating clockwise 45° from its initial state.

### NUMERAL REFERENCE

1—drive device; 11—drive shaft; 21—chain; 22—sprocket; 23—chain guide plate; 231—guide sliding groove; 3—lithium battery; 4—first support device; 41—left shell; 42—right shell; 43—grip part; 44—first installation part; 441—first cavity; 442—first rotation surface; 443—rotating shaft part; 444—oil injection hole; 445—hollow area; 45—protective board; 46—auxiliary handle; 5—second support device; 51—rotation guide plate; 511—second rotation surface; 512—third rotation surface; 513—shaft sleeve portion; 514—convex platform; 5141—positioning protrusion; 515—guide rail; 516—sector limit portion; 5161—limit slot; 517—oil guide groove; 518—oil storage tank; 519—oil guide hole; 52—cover plate; 521—indication arrow; 53—second cavity; 532—comb teeth; 541—first sealing ring; 542—second sealing ring; 551—T-shaped screw; 552—nut; 553—tightening knob; 61—adjustment knob; 62—disk-shaped cam; 63—follower; 631—driven flat plate; 632—driven convex block; 6321—driven plane; 71—locking groove; 72—locking pin; 721—first stop portion; 73—locking knob; 74—reset spring; 75—unlocking groove; 751—second stop ring; 8—compression component; 81—compression plate; 82—limit claw; 821—cantilever portion; 822—claw portion; 83—positioning block; 84—positioning groove; 9—oil pot; 91—oil inlet nozzle.

### DESCRIPTION OF EMBODIMENTS

In order to clarify the purpose, technical solution, and advantages of the present disclosure, a detailed description of the present disclosure will be provided below in combination with the accompanying drawings and specific embodiments.

Here, it should be noted that in order to avoid blurring the present disclosure due to unnecessary details, only the structures and/or processing steps closely related to the solution of the present disclosure are shown in the accompanying drawings, and other details that are not closely related to the present disclosure are omitted.

Besides that, it should be noted that terms “including”, “containing”, or any other variation thereof are intended to encompass non-exclusive inclusion, such that a process, method, item, or device that includes a series of elements not only includes those elements, but also includes other elements that are not explicitly listed or are inherent to such a process, method, item, or device.

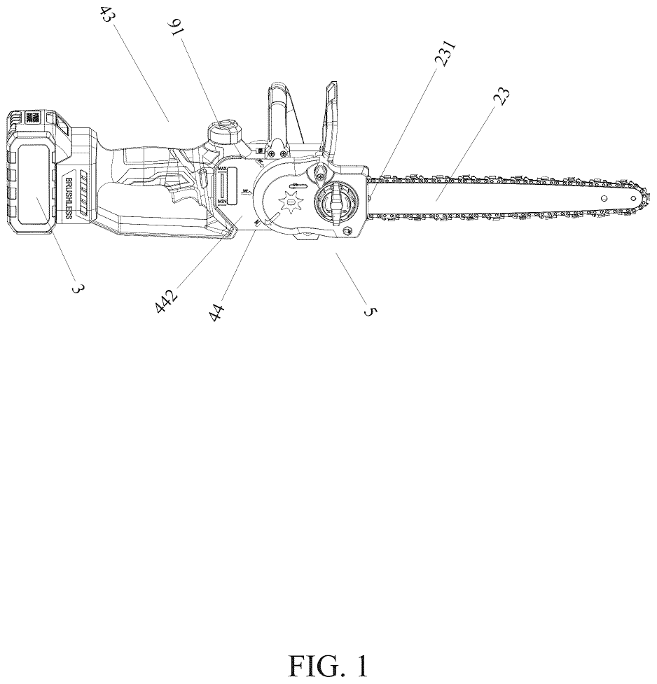

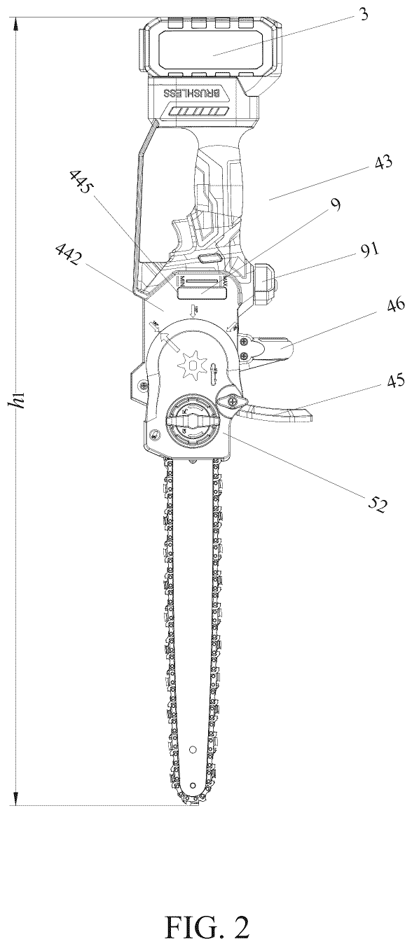

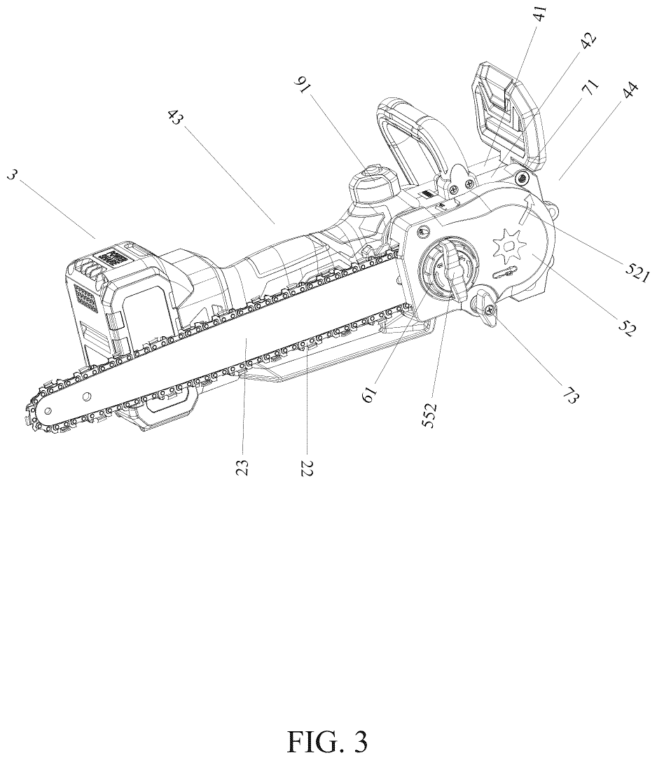

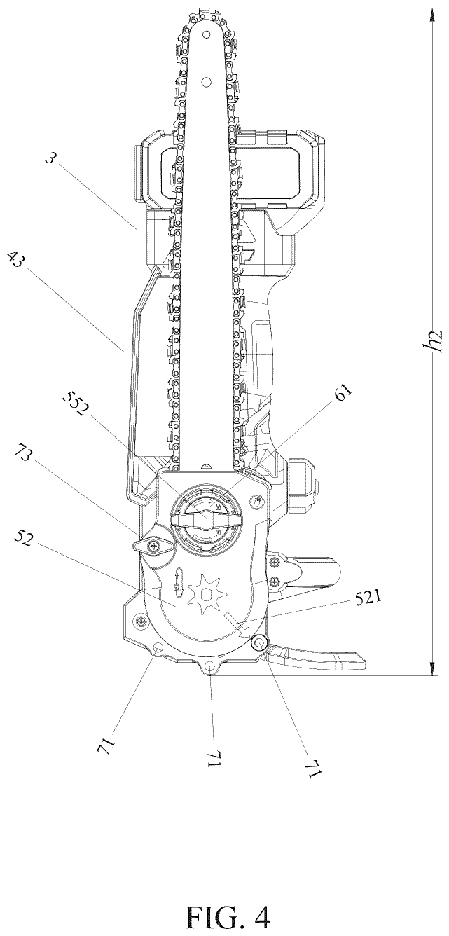

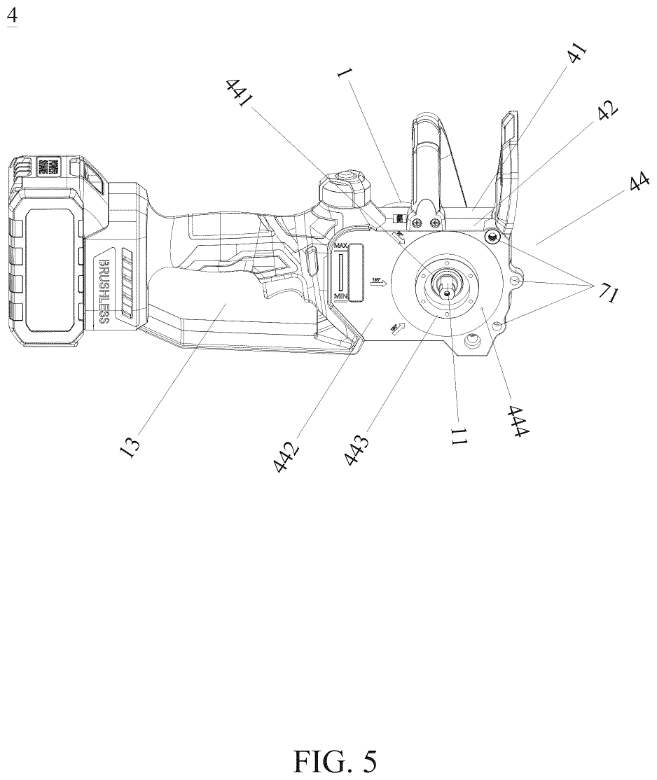

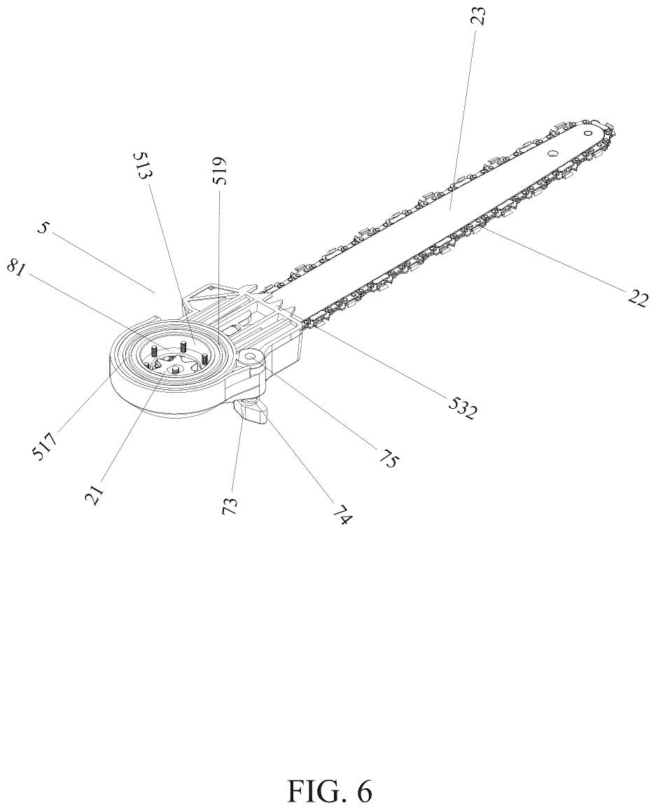

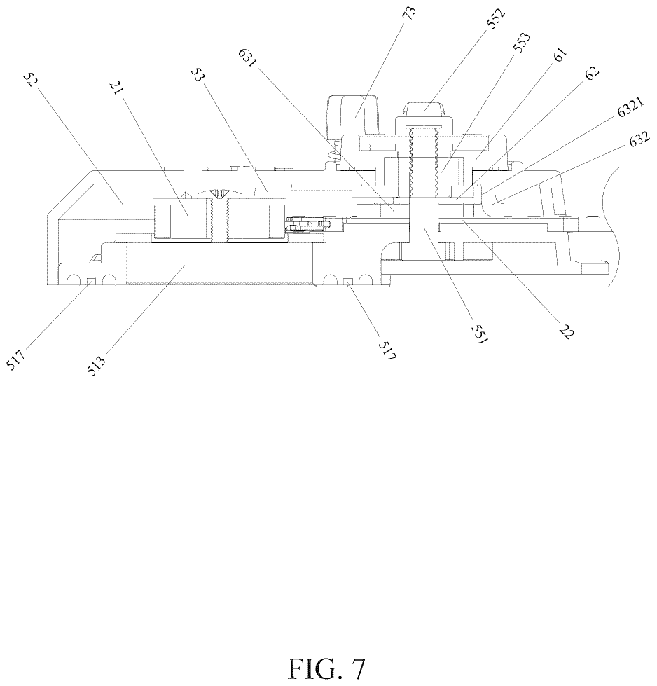

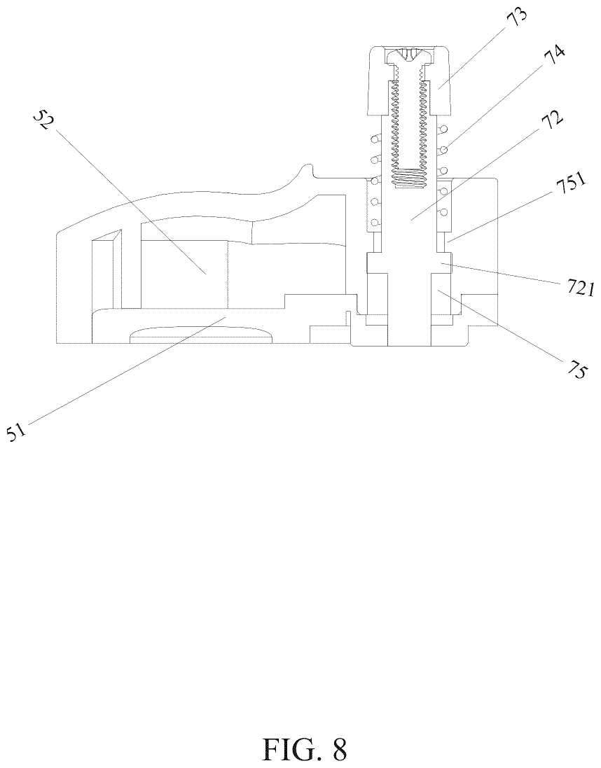

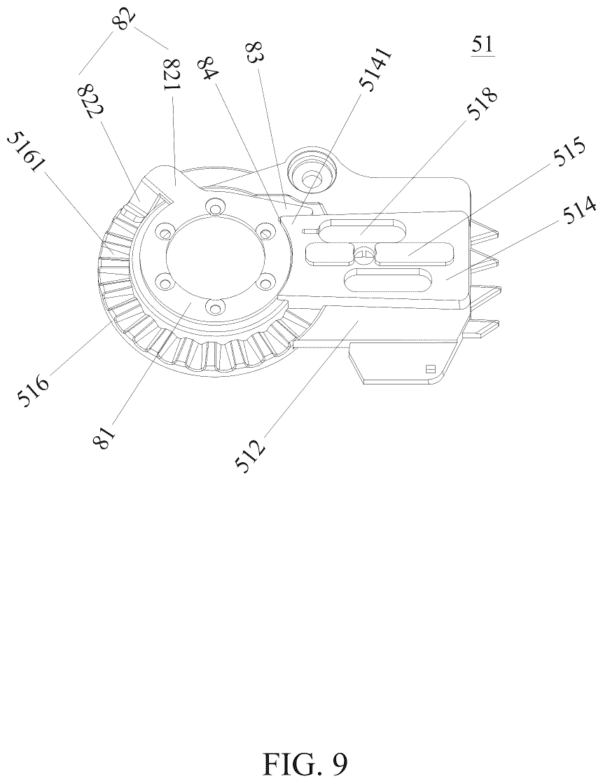

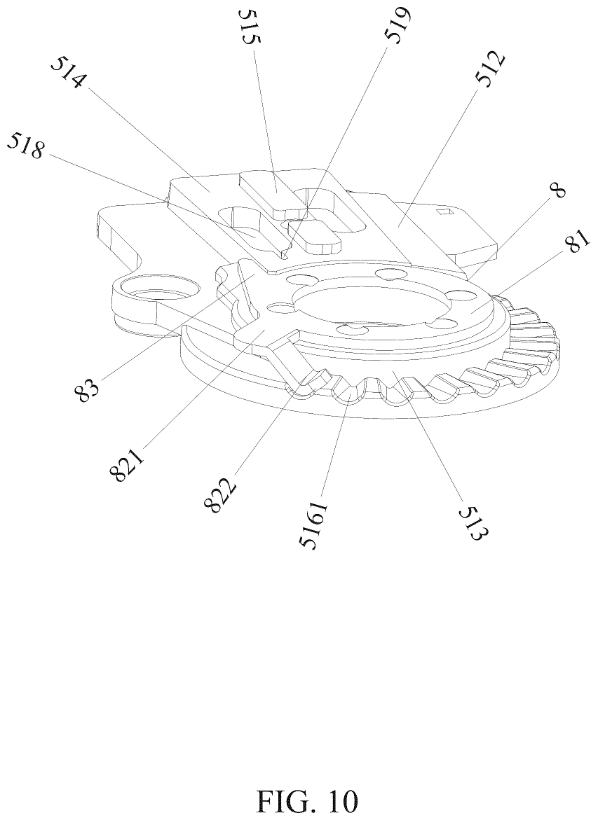

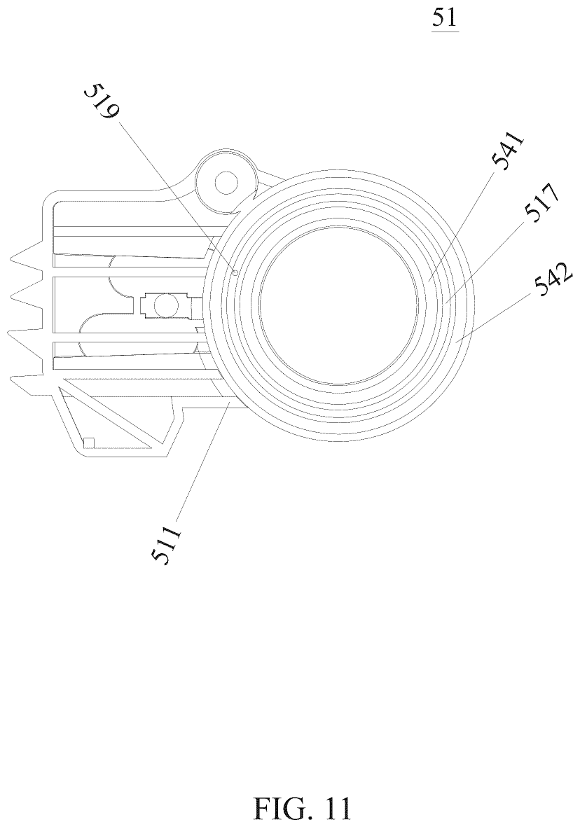

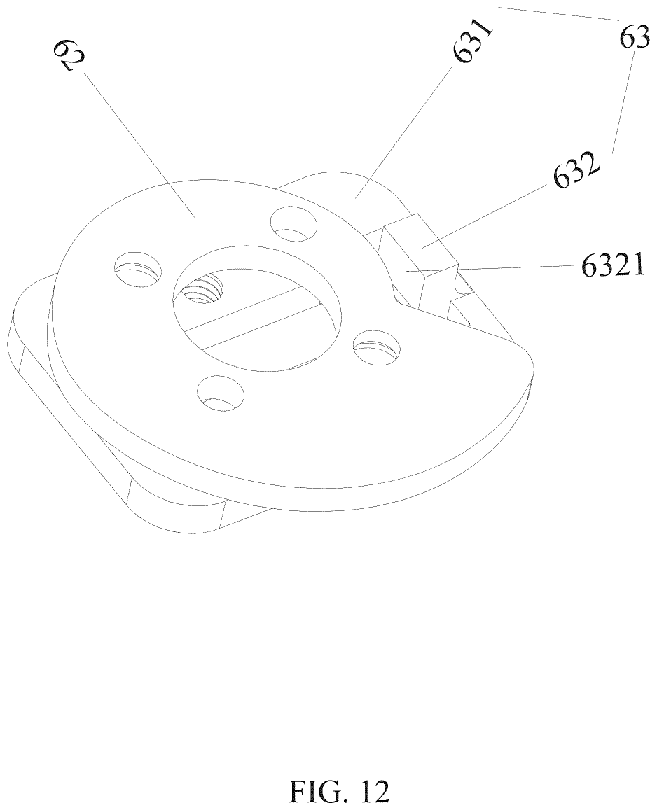

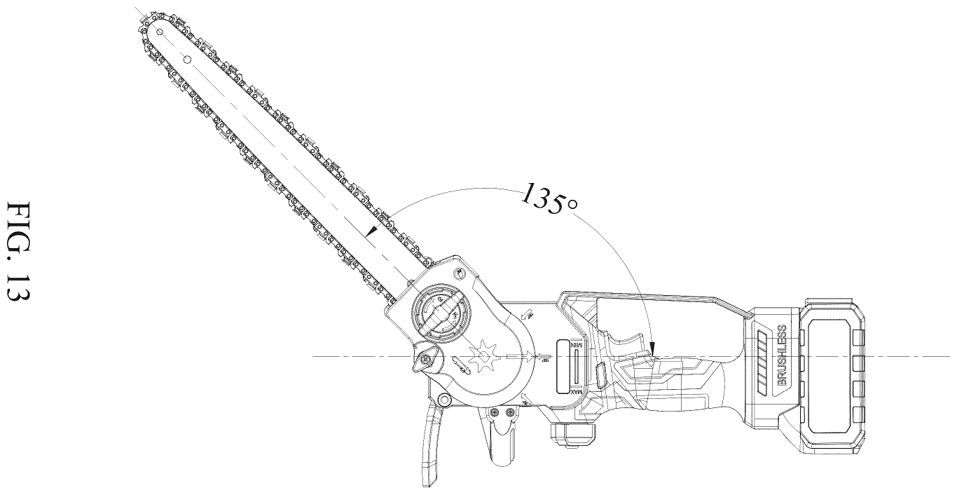

As shown in FIGS. 1-13, a foldable lithium electric saw includes a drive device 1, a tool assembly, a lithium battery 3, a first support device 4, a second support device 5, and an adjusting mechanism. The tool assembly includes a chain 21, a sprocket 22, and a chain guide plate 23. The sprocket 22 is connected to the drive shaft 11 for transmission, and is relatively fixed to the drive shaft 11 to ensure the stability of power transmission. In an implementation mode, the sprocket 22 is a nine-tooth sprocket, and the sprocket 22 meshes with the chain 21. The sprocket 22 and the chain guide plate 23 are cooperated to support the chain 21, ensuring the stability and safety of the chain 21 during operation. The drive device 1 provides power to the tool assembly through a drive shaft 11, ensuring the normal operation of the chain 21 and the sprocket 22, thereby achieving cutting function. The lithium battery 3 can supply power to the drive device 1. A first support device 4 includes a left shell 41 and a right shell 42, and the left shell 41 and the right shell 42 are configured to be assembled along a direction of the drive shaft 11 and define a grip part 43 and a first installation part 44. The first installation part 44 and the lithium battery 3 are respectively provided at two ends of the grip part 43. The first installation part 44 defines a first cavity 441, and a part of the drive device 1 is provided in the first cavity 441. The drive shaft 11 is arranged perpendicular to an extension direction of the first support device 4. The second support device 5 is configured to slide and support the chain guide plate 23. The second support device 5 is configured to rotate around the drive shaft 11 relative to the first installation part 44. The chain guide plate 23 and the chain 21 rotate synchronously with the second support device 5 to switch the tool assembly between an initial state and a folded state. The adjusting mechanism is configured to adjust a tension of the chain 21 by driving the chain guide plate 23 towards/away from the sprocket 22 along its length direction. In the initial state, an extension direction of the chain guide plate 23 is parallel to the extension direction of the first support device 4 and extends outward away from the grip part 43. In the folded state, the extension direction of the chain guide plate 23 is parallel to the extension direction of the first support device 4, and the chain guide plate 23 extends toward the grip part 43. The tool assembly switches from the initial state by rotating 180° to the folded state. In the folded state, an overall size of the chainsaw is significantly reduced, and an overall length h2 after folding is shortened to 60% of an initial overall length h1.

In this embodiment, the second support device 5 includes a rotation guide plate 51 and a cover plate 52. The rotation guide plate 51 and the cover plate 52 are configured to be assembled along the direction of the drive shaft 11 and define a second cavity 53. The second cavity 53 includes an outlet, and the outlet is provided with comb teeth 532 that can automatically clean wood chips and branches wrapped around the chain 21. The sprocket 22 is provided in the second cavity 53, and the drive shaft 11 is configured to extend into the second cavity 53 and connect the sprocket 22. The chain guide plate 23 extends out of the second cavity 53 through the outlet.

In this embodiment, the first installation part 44 includes a first rotation surface 442, and the rotation guide plate 51 includes a second rotation surface 511 and a third rotation surface 512 that are arranged opposite to each other, with the second rotation surface 511 facing the first rotation surface 442. The first rotation surface 442 is provided with a rotating shaft part 443, and the rotation guide plate 51 is provided with a shaft sleeve portion 513. The shaft sleeve portion 513 is sleeved on the rotating shaft part 443. A compression component 8 is arranged to face the third rotation surface 512, and the compression component 8 is connected to the rotating shaft part 443 and forms an axial limit on the rotation guide plate 51. The compression component 8 includes an annular compression plate 81, and an inner ring portion of the compression plate 81 is connected to the rotating shaft part 443 through a plurality of screws. An outer ring portion of the compression plate 81 contacts the rotating sleeve part 443. The third rotation surface 512 is provided with a convex platform 514, on which a guide rail 515 is provided. The chain guide plate 23 includes a guide sliding groove 231 arranged along its length direction. The guide rail 515 and the guide sliding groove 231 slide back and forth to eliminate deflection errors during the adjustment process.

In this embodiment, the adjusting mechanism includes an adjustment knob 61 and a cam assembly, the cam assembly includes a disk-shaped cam 62 and a follower 63 that are connected in a transmission way, the follower 63 includes a driven flat plate 631 and a driven convex block 632 that are integrated, the disk-shaped cam 62, the driven flat plate 631 and the chain guide plate 23 are parallel to each other, the driven flat plate 631 is connected to the chain guide plate 23, the driven convex block 632 includes a driven plane 6321, and the driven plane 6321 is arranged perpendicular to a length direction of the chain guide plate 23, an outer contour of the disk-shaped cam 62 contacts the driven plane 6321, and a force between the disk-shaped cam 62 and the follower 63 is arranged along the length direction of the chain guide plate 23. The disk-shaped cam 62 is connected to the adjustment knob 61. The adjustment knob 61 drives the disk-shaped cam 62 to rotate, and then the chain guide plate 23 is driven to approach/move away from the sprocket 22 through the follower 63.

In this embodiment, the rotation guide plate 51 and the cover plate 52 are detachably connected by a bolt structure for easy disassembly and maintenance. The bolt structure includes a T-shaped screw 551, a nut 552, and a tightening knob 553. The T-shaped screw 551 is provided on the rotation guide plate 51, and the tightening knob 553 is fixedly connected to the nut 552. The tightening knob 553 is provided on an outside of the cover plate 52, and the nut 552 extends into the second cavity 53 and is connected to threads by threaded connection. The T-shaped screw 551 is arranged along the direction of the drive shaft 11. Furthermore, the adjustment knob 61 is provided on the outside of the cover plate 52, and is coaxially arranged with the tightening knob 553. The tightening knob 553 cooperates with the cover plate 52 to form an axial limit for the adjustment knob 61, and the nut 552 is configured to pass through the adjustment knob 61 and forms a radial limit for it.

In this embodiment, the foldable lithium electric saw includes a locking device that is configured to limit a rotation of the second support device relative to the first support device. The locking mechanism includes a plurality of locking grooves 71, a locking pin 72, a locking knob 73, a reset spring 74, and an unlocking groove 75. The locking grooves 71 extend perpendicular to the first rotation surface 442 into the first cavity 441, and the unlocking groove 75 extends perpendicular to the second rotation surface 511 into the second cavity 53. The locking pin 72 is extendable and provided in the unlocking groove 75, and is parallel to the direction of the drive shaft 11. The locking knob 73 is configured to drive the locking pin 72 to rotate or separate from the locking grooves 71 to achieve locking/unlocking. When the locking pin 72 is inserted into one of the locking grooves 71, the tool assembly is in the initial state. The locking pin 72 includes a first stop portion 721 protruding radially along it, and a second stop ring 751 is provided inside the unlocking grooves 75. The first stop portion 721 and the second stop ring 751 are in contact to limit the locking pin 72 from disengaging from the unlocking groove 75. Two ends of the reset spring 74 are in contact with the second stop ring 751 and the locking knob 73. The reset spring 74 drives the locking pin 72 to remain fully accommodated in the unlocking groove 75 to maintain the unlocked state.

In this embodiment, the third rotation surface 512 includes a sector limit portion 516 arranged around the shaft sleeve portion 513. The sector limit portion 516 includes a plurality of limit slots 5161 that are circumferential uniformly distributed. The compression component 8 includes limit claws 82 extending outward from the compression plate 81. The limit claws 82 include a cantilever portion 821 extending outward along one radial direction of the compression plate 81 and a clamping claw portion 822 arranged at a free end of the cantilever portion 821. The clamping claw portion 822 has a V-shaped structure. When the second support device 5 rotates, the claw portion 822 can be sequentially engaged with the limit slots 5161 one by one. A curvature of the sector limit portion 516 is π/2, and the limit claws 82 engage with the limit slots 5161 every time they switch, a second rotating mechanism is caused to rotate 15 degrees.

In this embodiment, the first rotation surface 442 includes a plurality of indicator marks, and the cover plate 52 includes an indication arrow 521, and the indication arrow 521 can be selectively aligned with one of the indicator marks to indicate a rotation angle. The indicator markers include three indicators: 90°, 135°, and 180°. An angle between adjacent indicators is 45°, which is three times an angle between adjacent limit slots 5161. The locking grooves 71 correspond one-to-one with the indicator marks, or the locking grooves 71 only correspond to a 180° indicator mark. One corresponding locking groove 71 is symmetrical with the indicator marks about a center of the sprocket 22. A user can intuitively understand a folding angle and a state of the device, rendering an operation more intuitive and convenient.

In this embodiment, the compression component 8 further includes a positioning block 83, and the positioning block 83 surrounds the compression plate 81 to form a positioning groove 84. The convex platform 514 includes a positioning protrusion 5141. When the positioning protrusion 5141 is inserted into the positioning groove 84, the tool assembly is in the initial state, and the second support device 5 can only rotate in one direction.

In this embodiment, the first rotation surface 442 is provided with an oil injection hole 444, and the rotation guide plate 51 includes an oil guide groove 517 provided on the second rotation surface 511, an oil storage tank 518 provided on the third rotation surface 512, and an oil guide hole 519 communicating the oil guide groove 517 and the oil storage tank 518. The oil guide groove 517 is arranged to face the first rotation surface 442, and an inner side and an outer side of the oil guide groove 517 in radial direction are respectively provided with a first sealing ring 541 and a second sealing ring 542. The oil storage tank 518 is arranged to face the chain 21. The first installation part 44 is provided with an oil pot 9 that stores lubricating oil and an oil pump. The oil pump is configured to pump the lubricating oil into the oil guide groove 517 through the oil injection hole 444, and then the lubricating oil flows into the oil storage tank 518 and lubricates the chain 21. Compared to the existing technology of setting the oil injection hole 444 on the first installation part 44, this design can prevent the lubricating oil splashing and achieve higher overall cleanliness.

In this embodiment, the first rotation surface 442 is further provided with a hollow area 445. The user can observe remaining oil level in the oil pot 9 through the hollow area 445, replenish lubricating oil in a timely manner, ensure that the chain 21 is always in a good lubrication state, extend the service life of the chain 21 and the electric saw, and reduce maintenance costs. The oil pot 9 is provided with an oil inlet nozzle 91, and the oil inlet nozzle 91 protrudes from the first shell and is exposed to an outside.

In this embodiment, a protective board 45 is rotatably provided on an upper surface of the first installation part44, and an auxiliary handle 46 is provided on a left side of the first installation part44.

The above embodiments are only used to illustrate the technical solution of the present disclosure and not to limit it. Although the present disclosure has been described in detail with reference to the preferred embodiments, those skilled in the art should understand that the technical solution of the present disclosure can be modified or equivalently replaced without departing from the spirit and scope of the technical solution of the present disclosure.

1. A foldable lithium electric saw, comprising:
a drive device, which comprises a drive shaft;
a tool assembly, which comprises a chain, a sprocket, and a chain guide plate, wherein the sprocket is connected to the drive shaft for transmission, the sprocket is configured to be fixed to the drive shaft, the sprocket and the chain guide plate are configured to cooperate to support the chain, and the sprocket meshes with the chain;
a first support device, which comprises a grip part and a first installation part provided at one end of the grip part, the drive device is provided on the first installation part, and the drive shaft is arranged perpendicular to an extension direction of the first support device;
a second support device, configured to slidably support the chain guide plate, wherein the second support device is configured to rotate around the drive shaft relative to the first installation part, and the chain guide plate and the chain rotate synchronously with the second support device to switch the tool assembly between an initial state and a folded state;
an adjusting mechanism, configured to adjust a tension of the chain by driving the chain guide plate to approach/move away from the sprocket along its length direction;
wherein in the initial state, an extension direction of the chain guide plate is parallel to the extension direction of the first support device and extends outward away from the grip part; in the folded state, the extension direction of the chain guide plate is parallel to the extension direction of the first support device, and the chain guide plate extends toward the grip part; the tool assembly is configured to switch from the initial state by rotating 180° to the folded state;
wherein the second support device comprises a rotation guide plate and a cover plate, wherein the rotation guide plate and the cover plate are configured to be assembled along a direction of the drive shaft and define a cavity, the cavity comprises an outlet, the sprocket is provided in the cavity, the drive shaft is configured to extend into the cavity and connect the sprocket, and the chain guide plate extends out of the cavity through the outlet;
the first installation part comprises a first rotation surface, and the rotation guide plate comprises a second rotation surface and a third rotation surface that are arranged opposite to each other;
the second rotation surface is arranged opposite to the first rotation surface, and the third rotation surface is provided with a guide rail; the chain guide plate comprises a guide sliding groove arranged along its length direction, and the guide rail is in a reciprocating sliding cooperation with the guide sliding groove.

2. (canceled)

3. The foldable lithium electric saw according to claim 1, wherein the adjusting mechanism comprises an adjustment knob and a cam assembly,
wherein the cam assembly comprises a disk-shaped cam and a follower connected by a transmission, the follower is connected to the chain guide plate, the disk-shaped cam is connected to the adjustment knob, and the adjustment knob drives the disk-shaped cam to rotate, thereby driving the chain guide plate to approach/move away from the sprocket through the follower.

4. The foldable lithium electric saw according to claim 3, wherein the follower comprises a driven flat plate and a driven convex block that are integrated,
the disk-shaped cam, the driven flat plate, and the chain guide plate are parallel to each other,
the driven flat plate is connected to the chain guide plate,
the driven convex block comprises a driven plane, the driven plane is arranged perpendicular to a length direction of the chain guide plate, an outer contour of the disk-shaped cam is in contact with the driven plane, and when the disk-shaped cam rotates, a force between the disk-shaped cam and the follower is arranged along the length direction of the chain guide plate.

5. The foldable lithium electric saw according to claim 1, further comprises a locking mechanism configured to limit a rotation of the second support device relative to the first support device,
wherein the locking mechanism comprises:
at least one locking groove extending inward perpendicular to the first rotation surface;
a locking pin, which is extendable and provided on the second support device and is arranged parallel to the direction of the drive shaft,
a locking knob, configured to drive the locking pin to rotate or separate from the locking groove to achieve locking/unlocking; when the locking pin is inserted into the at least one locking groove, the tool assembly is in the initial state;
a reset spring, configured to drive the locking pin to withdraw from the at least one locking groove to maintain an unlocked state.

6. The foldable lithium electric saw according to claim 5, wherein the locking pin comprises a first stop portion protruding radially along the locking pin,
the second support device is provided with an unlocking groove, and a stop ring is provided inside the unlocking groove; the first stop portion is in contact with the stop ring to limit the locking pin from disengaging from the unlocking groove, and two ends of the reset spring are in contact with the stop ring and the locking knob; the reset spring drives the locking pin to remain completely accommodated in the unlocking groove.

7. The foldable lithium electric saw according to claim 5, wherein the first rotation surface is provided with a rotating shaft part, the rotation guide plate is provided with a shaft sleeve portion, the shaft sleeve portion is sleeved on the rotating shaft part, a compression component is provided on the third rotation surface, the compression component is connected to the rotating shaft part and forms an axial limit on the rotation guide plate,
wherein the compression component comprises an annular compression plate, an inner ring portion of the compression plate is connected to the rotating shaft part through a plurality of screws, and an outer ring portion of the compression plate is in contact with the shaft sleeve portion.

8. The foldable lithium electric saw according to claim 7, wherein the third rotation surface comprises a sector limit portion arranged around the shaft sleeve portion, the sector limit portion comprises a plurality of limit slots uniformly distributed in a circumferential direction, and the compression component comprises limit claws extending outward from the compression plate;
when the second support device rotates, the limit claws are configured to be engaged with the limit slots one by one.

9. The foldable lithium electric saw according to claim 8, wherein it satisfies at least one of the following:
the limit claws comprise a cantilever portion extending radially outward along the compression plate and a claw portion provided at a free end of the cantilever portion, the claw portion has a V-shaped structure;
the first rotation surface comprises a plurality of indicator marks, and the cover plate comprises an indicator arrow that is configured to be selectively aligned with one of the indicator marks to indicate a rotation angle; the at least one locking groove comprises locking grooves corresponding one-to-one with the indicator marks, and each of the locking grooves and its corresponding indicator mark are symmetrical about a center of the sprocket.

10. The foldable lithium electric saw according to claim 1, wherein the first rotation surface is provided with an oil injection hole, and the rotation guide plate comprises an oil guide groove provided on the second rotation surface, an oil storage tank provided on the third rotation surface, and an oil guide hole commutating the oil guide groove and the oil storage tank;
the oil guide groove is arranged towards the first rotation surface, and inner and outer sides of the oil guide groove in a radial direction are respectively provided with a first sealing ring and a second sealing ring; the oil storage tank is arranged towards the chain;
the first installation part is provided with an oil pot storing lubricating oil and an oil pump; the oil pump is configured to pump the lubricating oil into the oil guide groove through the oil injection hole, and then the lubricating oil flows into the oil storage tank and lubricates the chain.
